(19) United States
(12) Patent Application Publication
(10) Pub. No.: US 2026/0184032 A1
(43) Pub. Date: Jul. 2, 2026

(54) METHOD AND APPARATUS FOR PRODUCING A NON-PNEUMATIC TYRE

(71) Applicant: KRAUSSMAFFEI EXTRUSION GMBH, Laatzen (DE)

(72) Inventors: Mathias ZABEL, Wieckenbert (DE); Sebastian SCHMIDHUBER, Munchen (DE)

(21) Appl. No.: 18/899,777

(22) PCT Filed: Mar. 20, 2023
(86) PCT No.: PCT/EP2023/056990

§ 371 Date: Sep. 27, 2024

(30) Foreign Application Priority Data
Apr. 6, 2022 (DE) 10 2022 108 267.9

(51) Int. Cl. B29D 30/02; B29K 105/24

(52) U.S. Cl. CPC B29D 30/02; B29K 2105/24

(57) ABSTRACT

A method is provided for producing a non-pneumatic tire, which has a tread, such as a tire tread, with an outer side and an inner side opposite the outer side. The method includes the steps of: providing the tread, substantially in annular form, inside a mould, in particular a tire mould; pressing the tread, in particular the outer side thereof, against a mould surface, such as a moulding surface, of the mould; and introducing a temporarily heat-releasing compound into the cavity delimited by the tread, wherein the heat released by the compound introduced into the cavity causes vulcanisation of at least a section of the tread to occur or to at least be initiated, wherein the heat-releasing compound is a reactive mixture, in particular a polyurethane reactive mixture, consisting of at least two reactive components, such as polyol and isocyanate, or wherein the heat-releasing compound is a melt, in particular a plastic melt. Also provided is a device that is configured and intended to carry out such a method.

The invention relates to a method for producing a non-pneumatic tire. Furthermore, the invention relates to an apparatus for producing a non-pneumatic tire.

Concepts for airless tires, also called non-pneumatic tires, are partially known for commercial vehicles, such as small excavators, and consumer goods, such as lawn mowers, strollers, etc. Airless can be understood to mean that the tire is not filled with compressed air. There are now also considerations about using airless tires in motor vehicles, such as passenger vehicles.

In non-pneumatic tires, the air chamber is usually replaced by specially shaped plastic spokes, the intermediate spaces of which are open. One advantage of tires without an air chamber (Non-Pneumatic Tire, NPT) can be that such tires cannot suffer from pressure loss because there is no air chamber that can be damaged and/or is filled with compressed air. Furthermore, an airless tire has comparatively few components and can therefore enable good retreading and good disposal or recycling after the end of its use.

For example, a non-pneumatic tire is known from document EP 3 071 424 B1, having a support structure comprising an outer reinforced annular band, a hub, and a set of stress-transmitting elements extending between the hub and radially inward from the outer reinforced annular band.

Furthermore, an apparatus for vulcanizing tires is known from document US 2009/0211689 A1, comprising a chamber 10 for receiving a tire assembly 50, a heat exchanger 20 connected to the chamber 10, a heating unit 30 for heating water for the heat exchanger 20, and a pump 40 for circulating a water flow between the heating unit 30 and the heat exchanger 20. The chamber 10 is designed as a tire vulcanizing press and the heat exchanger 20 has a heating bellows which can be arranged inside a tire cavity. Furthermore, a circuit is provided for guiding the water flow through sections of the vulcanizing press which surround the exterior of the tire.

Conventional non-pneumatic tires can exhibit adverse behavior when there are contaminants, such as stones or ice in winter, in the openings between the spokes. The materials used can also sometimes have material changes after years of exposure to UV light or numerous other environmental influences that occur in road use, such as heat or cold, or even solvents or cleaning agents. Such material changes can have a negative effect on the behavior of the tire. Furthermore, the known production methods do not enable a marketable cost profile, since the components have to be manufactured largely in separate steps and then finally joined. This is complex, requires space-intensive logistics processes, and is very costly.

The invention is based on the object of functionally improving a method mentioned at the outset for producing a non-pneumatic tire. Furthermore, the invention is based on the object of structurally and/or functionally improving an apparatus mentioned at the outset for producing a non-pneumatic tire. Therefore, it is an object of the present invention to provide a method and an apparatus which reduce or eliminate the problems identified in connection with the prior art. In particular, it is an object of the present invention to reduce the expenditure and to achieve a high level of vertical integration. Furthermore, time-consuming and space-intensive logistics and process sequences are to be reduced or completely avoided.

The object is achieved by a method having the features of claim 1. Furthermore, the object is achieved by an apparatus having the features of claim 19. Advantageous embodiments and/or refinements are the subject of the subclaims, the description, and/or the accompanying figures. In particular, the independent claims of one claim category can also be refined and/or combined analogously to the dependent claims of another claim category. Likewise, the apparatus and method features described below can be combined with one another and/or refined.

One aspect relates to a method for producing a non-pneumatic tire. The tire can be an airless or compressed air-free tire. The tire may be a vehicle tire, such as a motor vehicle tire. The tire can have a tread, such as a tire tread. The tread can have an outer side and an inner side opposite to the outer side. A radially outer surface, such as an outer surface, can be provided on the outer side. An outer tread section can be provided on the outer side. The tread section can be radially outward. The outer surface and/or the tread section can form a running surface of the tire, such as a tire running surface, on which the tire rolls during operation. The outer surface and/or the tread section and/or the running surface can have and/or form a complete or incomplete or no profile, such as a tire profile. The profile can have grooves, such as longitudinal grooves and/or transverse grooves. A radially inner surface, such as an inner surface, can be provided on the inner side. An inner wheel section can be provided on the inner side. The tread can be produced from multiple different layers and/or materials. The materials can be natural rubber or vulcanized rubber materials or natural rubber or vulcanized rubber mixtures. The tread can be a semi-finished product. The tread can be a multilayer tread. The tread can be or have a multilayer tire profile. Terms such as “inner,” “outer,” “radial,” and “circumferential” can refer to the axis of rotation of the tire.

The method can comprise the following step: providing the tread substantially in annular shape within a mold. The mold can be a tire mold. The tread can be formed or bent into a ring and then introduced, for example inserted, into the mold, for example into a cavity of the mold. The tread can be inserted in a ring shape into the mold or into the cavity of the mold.

The tread can be produced, at least in sections, from a natural rubber material or vulcanized rubber material. For example, the tread can be produced using an extrusion system, for example extruded. The production of the tread can take place before the provision of the tread, in particular before the tread is introduced into the mold.

A reinforcing layer can be attached to the inner side of the tread. The reinforcing layer can be attached to the inner wheel section. The reinforcing layer can be a metal-reinforced layer, such as a natural rubber or elastomer layer. The reinforcement layer can comprise metal fibers or a metal mesh. The metal fibers or metal mesh can be impregnated with natural rubber or an elastomer. The metal can be steel. An adhesion promoter can be applied to the inner side of the tread or wheel section or to the inner side of the reinforcing layer. Additionally or alternatively, polar or non-polar substances/materials can be used and/or applied. In this way, sufficient adhesion between these materials can be established or achieved. The use of an adhesion promoter can then be omitted.

The method can comprise the following step: pressing the tread, in particular its outer side, against a forming surface, such as a shaping surface, of the mold. The outer surface and/or the tread section and/or the running surface of the tread can be pressed against the forming surface of the mold. The forming surface and/or the cavity can be substantially annular. By pressing the tread, in particular its outer side, against the forming surface of the mold, a profile surface, in particular a tire profile, can be created. The forming surface can be a contoured surface and/or have a profile formed complementary to a tire profile, so that when the tread is pressed against the forming surface, the tire profile is formed in the tread. Pressing can also be understood as compressing. The pressing or compressing can be carried out by means of a hydraulic and/or pneumatic tool. The hydraulic and/or pneumatic tool can be or have a pressing tool and/or a hydraulically and/or pneumatically actuatable bellows, such as a folded bellows. The hydraulic and/or pneumatic tool can be introduced, for example retracted or pivoted, into the mold or into its cavity, at least in sections, in particular before the pressing process or compressing process. The hydraulic and/or pneumatic tool can be introduced, for example retracted or swiveled, into the cavity delimited by the tread, at least in sections, in particular before the pressing process or compressing process. The cavity delimited by the tread can be the area extending radially inward from the inside of the tread. By actuating the hydraulic and/or pneumatic tool, the tread, in particular its outer side, can be pressed, in particular compressed, against the forming surface of the mold.

The mold and/or its forming surface can be heated. The mold can be heated by means of a heating device. A predefined temperature level can be maintained or the temperature can be variably adjusted.

The method can comprise the following step: introducing a temporarily heat-emitting compound into the cavity delimited by the tread. The introduction can be filling, injecting, or pouring. The cavity delimited by the tread can be completely or only partially filled with the compound. The cavity delimited by the tread can be the air chamber of the tire. The air chamber of the tire can be completely or only partially filled with the compound. The compound can be designed to temporarily emit heat. The compound can cool down in this case. The heat emitted by the compound introduced into the cavity can cause or at least initiate vulcanization of at least one section, such as the natural rubber section, of the tread. The vulcanization can be the vulcanization of a natural rubber of the tread, in particular to form vulcanized rubber.

The heat-emitting compound can be a reactive mixture consisting of at least two reactive components. The reactive mixture can be a polyurethane reactive mixture. The at least two reactive components can be polyol and isocyanate. The reactive mixture can be a foam mixture, such as a plastic foam mixture. The reactive mixture can be based on polyurethane (PUR). The reactive mixture can form a foam, in particular a solid foam, for example plastic foam or polyurethane foam. The heat-emitting compound, in particular the reactive mixture, can be introduced into the cavity delimited by the tread by means of a mixing head, for example injected or poured. The mixing head can be a low-pressure or high-pressure mixing head. The mold can be coupled with the mixing head. The mixing head can be moved or introduced and/or pivoted towards and/or at least partially into the cavity of the mold by means of a moving apparatus such as a robot or robot arm. The mixing head can have a nozzle unit for discharging the reaction mixture. The at least two reactive components can be introduced, for example metered, into the mixing head. The at least two reactive components can be mixed with each other in the mixing head, in particular to form the reactive mixture. The reactive mixture can be produced and/or created by means of the mixing head. The mixing head can be part of a reaction casting system. The reactive mixture can cause an exothermic reaction. The reactive mixture can temporarily emit heat, such as heat of reaction. The reaction mixture can cure, in particular to form a foam. The curing can be caused by the reaction and/or can take place with heat emission. The vulcanization of at least one section, such as the natural rubber section, of the tread can take place or at least be initiated by means of the temperature of the mold and/or by means of the exothermicity or the heat emitted by the reaction and/or polymerization reaction of the reactive mixture. The reaction and/or polymerization process of the reactive mixture can take place or be initiated at the same time or with overlap. A temperature level can be maintained or variably adjusted, in particular until the reaction and/or polymerization process of the reactive mixture and/or the vulcanization is completed. An exothermic level or a specific heat emission of the reaction and/or polymerization reaction of the reactive mixture can be maintained and/or the reaction and/or polymerization process of the reactive mixture can take place until the vulcanization is completed.

The heat-emitting compound can be a melt. The melt can be a plastic melt. The melt can be produced and/or created by means of an injection molding machine. The heat-emitting compound, in particular the melt, can be introduced, for example injected, into the cavity delimited by the tread by means of an injection unit of the injection molding machine. The injection unit can be an injection and closing unit. The mold can be coupled with the injection unit or with the injection and closing unit of the injection molding machine. By means of the injection molding machine, the melt can be brought to a specific temperature, such as melting temperature. By means of the melt temperature and/or due to the heat emission of the melt, the vulcanization of at least one section, such as the natural rubber section, of the tread can take place or at least be initiated. The melt temperature can be maintained, for example above the temperature of the mold, until the vulcanization is complete. Melt cooling and vulcanization can occur at the same time or with overlap. The melt can solidify, in particular with heat emission.

At least one supporting structure, such as an insert, can be introduced into the cavity delimited by the tread, in particular additionally. The support structure can be introduced before the introduction of the heat-emitting compound. The support structure can be composed of multiple struts. The support structure can be produced from plastic and/or metal.

After completion of the polymerization, solidification, or vulcanization process, at least one post-processing step can take place. The at least one post-processing step can comprise removing the tire from the mold, deburring, tempering, or the like.

A further aspect relates to an apparatus for producing a non-pneumatic tire. The tire can have a tread, such as a tire tread. The tread can have an outer side and an inner side opposite to the outer side. The tire and/or the tread can be designed as described above and/or below. The apparatus can be configured and/or intended to carry out the method described above and/or below for producing the non-pneumatic tire.

The apparatus can have a mold. The mold can be a tire mold. The mold can be a press, such as a tire press, for example a tire heating press. The mold can be a vulcanizing device. The mold can have a forming surface, such as a shaping surface, for forming the tread, in particular the outer surface of the tread. The mold can have a cavity. The forming surface can be arranged in the cavity and/or delimit it. The forming surface and/or the cavity can be essentially annular and/or circular and/or cylindrical. The forming surface can be a contoured surface. The forming surface can have a profile which is designed to be complementary to a tire profile.

The apparatus can have a heating device for heating the mold and/or the forming surface. The heating device can be designed to maintain a predefined temperature level or to adjust the temperature variably.

The apparatus can have a hydraulic and/or pneumatic tool. The hydraulic and/or pneumatic tool can be designed to be introduced into the mold at least in sections. The hydraulic and/or pneumatic tool can be designed to press, in particular to compress, the tread, in particular its outer side, against the forming surface of the mold. The hydraulic and/or pneumatic tool can be or have a pressing tool and/or a hydraulically and/or pneumatically actuatable bellows, such as a folded bellows.

The device can have a mixing head or a reaction casting system having a mixing head for introducing the heat-emitting compound, in particular the reaction mixture, into the cavity delimited by the tread. The mixing head can be a low-pressure or high-pressure mixing head. The mold can be coupled with the mixing head. The apparatus can have a movement device, such as a robot or robot arm. The movement apparatus can be coupled with the mixing head. The movement apparatus can be designed to move or introduce and/or pivot the mixing head towards and/or at least in sections into the cavity of the mold. The mixing head can have a nozzle unit for discharging the reaction mixture.

The apparatus has an injection unit or injection and closing unit for introducing the heat-emitting compound, in particular the melt, into the cavity delimited by the tread. The apparatus can have an injection molding machine having an injection unit or injection and closing unit for introducing the heat-emitting compound, in particular the melt, into the cavity delimited by the tread. The mold can be coupled with the injection unit or with the injection and closing unit of the injection molding machine.

In summary and in other words, the invention thus provides, among other things, a method and an apparatus for producing airless vehicle tires. Highly integrated manufacturing can be provided, in which there is, in particular, only one upstream step for the manufacturing and optionally conditioning of a semi-finished product, such as treads. The semi-finished product can then be inserted into a subsequent process. From then on, all further process steps can in principle take place in a variable cavity. A reactive “RPM” process route or a thermoplastic “IMM” process route can be provided. Both process routes can begin with the production of a tread, such as a tire running surface. Steel cord/steel mesh-reinforced natural rubber or elastomer can then be added or attached to the underside of the tread. However, the profile surface may not yet have a complete profile. Only the longitudinal grooves can be incorporated. The multi-layer tire profile, such as treads, can now be conditioned as a semi-finished product on the inner side for the subsequent steps, if necessary applying an adhesion promoter, and then inserted in a ring shape into the cavity of a mold. Depending on the design of the system, process, and tool, either the RPM or the IMM process route can furthermore be provided. In a first substep, a tool upper part can be introduced, which presses the tread against a correspondingly contoured outer side of the tool in the lower part via a liquid-operated or gas-operated, for example pneumatic, bellows, and thus incorporates the later tire profile. After this process step, the tool upper part can retract and another is introduced, which can then initiate the RPM or IMM process route, depending on the design. In the RPM process variant, a corresponding reaction technology system according to the low-pressure or high-pressure principle can be connected to the tool, such as a mold. The components involved can be mixed in a mixing head and introduced into the cavity. The process parameters can be selected so that the mold temperature and exothermicity of the polymerization reaction can be used to initiate the reaction/polymerization process of the reactive mixture and the vulcanization of the natural rubber to form vulcanized rubber simultaneously or in an overlapping manner. This temperature level can then be maintained or can also be made variable until polymerization and vulcanization are complete.

For example, in the RPM process variant, the mold profile can be created by means of a pneumatic bellows, then polyurethane mixture (PUR) is poured in and the temperature of the mold and the exothermic energy can be used to cure the polyurethane mixture and to trigger or start the vulcanization process. The exothermic level can be maintained until the vulcanization is complete. In the IMM process variant, the tool can be coupled with a corresponding injection and closing unit and the melt can be introduced into the cavity. Here, the melt temperature can be used in such a way that the melt can be introduced first and the vulcanization of the natural rubber to form vulcanized rubber can be initiated. The profile of the temperature curve can then be selected so that melt cooling and vulcanization can take place simultaneously or overlapping. For example, in the IMM process variant, the mold profile can be created by means of a pneumatic bellows, then melt can be injected and the melting temperature can be used to trigger vulcanization. The melt temperature can be maintained above the temperature level of the mold until the vulcanization is complete. If necessary, supporting structures, such as inserts or the like, can be introduced into both process routes by appropriate automation. After completion of the polymerization, solidification, and/or vulcanization step, post-processing steps, e.g., deburring, tempering, etc., can be carried out. There may be additional effects on the chemical side. For example, polar or non-polar materials can be used. The adhesion promoters frequently used to ensure sufficient adhesion between these materials may then optionally be omitted.

Using the invention, the process technology and the process sequence can be simplified, in particular by using properties of one process step to initiate or promote the subsequent one. A high degree of integration can be made possible. Time-consuming and/or space-intensive logistics sequences or compensatory steps can be omitted. A high level of vertical integration can be achieved at the same production site. A complete production cell can have a small footprint in comparison to the vertical integration. Intermediate process steps such as balancing or compensating for shrinkage, for example by means of a follow-up injection in RPM processes or a follow-up compression in IMM processes, can be integrated. Costs can be reduced. Material properties of the airless tire can be optimally set or adjusted.

Exemplary embodiments of the invention are described in more detail hereinafter with reference to the figures, in the schematic figures, by way of example:

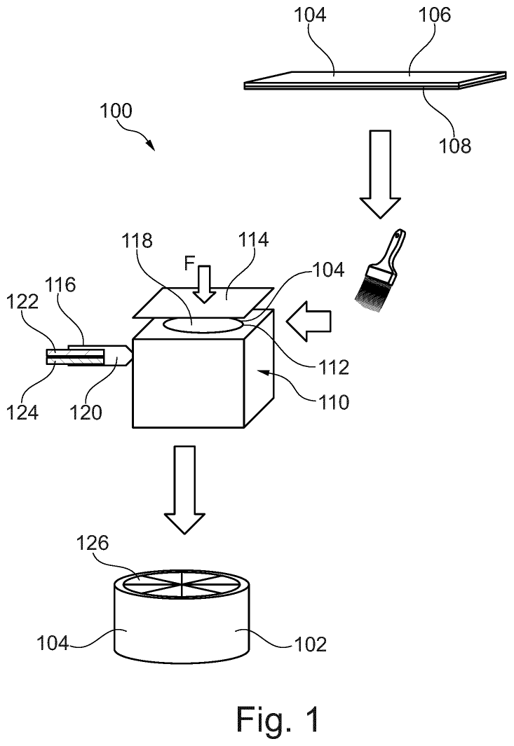

FIG. 1 shows an apparatus and a method according to an RPM process variant; and

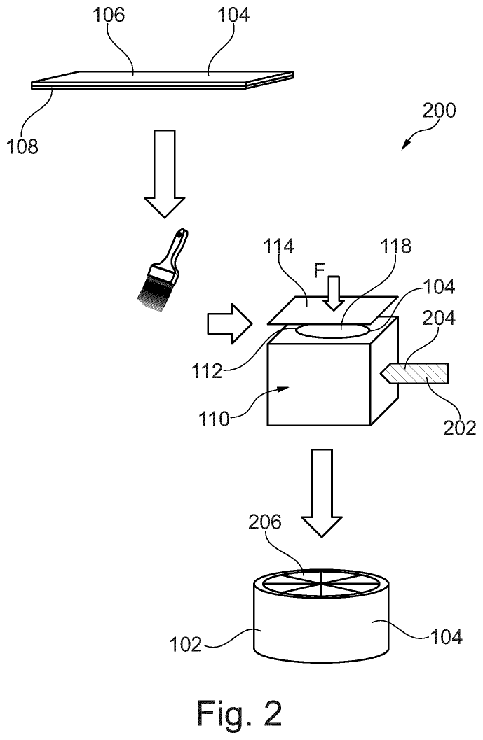

FIG. 2 shows an apparatus and a method according to an IMM process variant.

FIG. 1 schematically shows an apparatus 100 and a method according to an RPM process variant. The apparatus 100 is designed to produce a non-pneumatic tire 102. The tire 102 comprises a tread 104 or is produced therefrom. The tread 104 can be a semi-finished product produced by means of an extrusion system (not shown in FIG. 1) or can be produced using the extrusion system. The tread 104 can be produced entirely or at least in some sections from natural rubber material. The tread 104 has an outer side/surface 106 and an inner side/surface 108 opposite to the outer side 106.

The apparatus 100 has a mold 110, which is designed as a tire mold, having a forming surface 112 which is arranged in a cavity of the mold 110. The forming surface 112 is designed to form the tread 104, in particular the outer surface 106 of the tread 104 and for this purpose has a contoured surface and/or a profile formed complementary to a tire profile. Furthermore, the apparatus 100 has a heating device (not shown in FIG. 1) for heating the mold 110 or the forming surface 112.

Furthermore, the apparatus 100 comprises a hydraulic and/or pneumatic tool 114 which can be introduced at least in sections into the mold 110 or into the cavity of the mold 110 and is designed to press or compress the tread 104, in particular its outer side/surface 106, against the forming surface 112 of the mold 110. The hydraulic and/or pneumatic tool 114 can be a hydraulically and/or pneumatically operable bellows which is initially introduced into the cavity of the molding tool 110 without pressure and then presses the tread 104 radially outward against the forming surface 112 by applying pressure in order to introduce the tire profile into the tread 104.

In the present exemplary embodiment, the apparatus 100 has a mixing head 116 which is designed to introduce or to inject or pour a heat-emitting compound into the cavity 118 delimited by the tread 104. The mixing head 116 can be a low-pressure or high-pressure mixing head. The heat-emitting compound is a reactive mixture 120 consisting of at least two reactive components 122, 124, such as polyol and isocyanate, in particular a polyurethane reactive mixture.

Before the actual RPM process route starts, a reinforcing layer, in particular a metal-reinforced natural rubber or elastomer layer, can be applied to the inner side/surface 108 of the tread 104. Furthermore, an adhesion promoter can be applied to the inner side/surface 108 of the tread 104 or to an inner side of the reinforcing layer.

The tread 104 is then provided or inserted essentially in a ring shape within the mold 110. The hydraulic and/or pneumatic tool 114 is then at least partially introduced into the cavity 108 delimited by the tread 104. Then, by actuating the tool 114, the tread strip, in particular its outer side/surface 106, is pressed or compressed radially outwards against the forming surface 112 of the mold 110, as a result of which the tire profile is created in the tread 104. The mold 110 can be heated by means of the heating device.

Then, the heat-emitting compound or the reaction mixture 120 produced in the mixing head 116 is introduced or injected or poured into the cavity 118 delimited by the tread 104. The heat emitted by the reaction mixture 120 introduced into the cavity 118 causes vulcanization of at least one natural rubber section of the tread 104 or vulcanization is at least initiated or started using the heat emitted. For example, the vulcanization of at least one section of the tread 104 can be carried out or at least initiated or started by means of the temperature of the mold 110 set by the heating device and by means of the exothermicity or heat emission of the reaction or polymerization reaction of the reactive mixture 120. The reaction and/or polymerization process of the reactive mixture 120 can take place or at least be initiated at the same time or with overlap. A temperature level can be maintained or variably adjusted until the reaction and/or polymerization process of the reactive mixture 120 and/or the vulcanization is completed. For example, an exothermic level of the reaction and/or polymerization reaction of the reactive mixture 120 can be maintained and/or the reaction and/or polymerization process of the reactive mixture 120 can take place until the vulcanization is completed.

Meanwhile, the reactive mixture 120 introduced into the cavity 118 hardens to form a foam 126, such as polyurethane foam, and bonds with the annular tread 104, by which the airless tire 102 is formed.

FIG. 2 schematically shows an apparatus 200 and a method according to an IMM process variant. In contrast to the apparatus 100 according to FIG. 1, the apparatus 200 has, instead of the mixing head 116, an injection unit 202 of an injection molding machine (not shown in FIG. 2). The injection unit 202 can be designed as an injection and closing unit. The injection unit 202 is coupled with the mold 110 or will be coupled therewith. The injection unit 202 is designed to introduce a heat-emitting compound, in particular a melt 204, into the cavity 118 delimited by the tread 104. The melt 204 is a plastic melt 204 plasticized by means of the injection unit 202 or the injection molding machine.

In the present exemplary embodiment, instead of the reaction mixture 102, the plastic melt 204 is introduced or injected by means of the injection unit 202 into the cavity 118 delimited by the tread 104. The vulcanization of at least one section, such as the natural rubber section, of the tread 104 is carried out by means of the melt temperature or is at least initiated or started using the heat emitted by the plastic melt 204. The melt temperature can be maintained, in particular above the temperature of the mold 110, until the vulcanization is complete. Melt cooling and vulcanization can occur at the same time or with overlap.

Meanwhile, the plastic melt 204 introduced into the cavity 118 solidifies into a solid plastic material 206 and bonds with the annular tread 104, by which the airless tire 102 is formed.

In addition, reference is made in particular to FIG. 1 and the associated description.

In particular, “can” denotes optional features of the invention. Accordingly, there are also refinements and/or exemplary embodiments of the invention which additionally or alternatively have the respective feature or features.

Isolated features can also be singled out from the feature combinations disclosed in the present case, if necessary, and can be used to delimit the subject matter of the claim, dissolving any structural and/or functional relationship which may exist between the features, in combination with other features. The order and/or number of steps of the method can be varied. The methods and/or steps can be combined.

List of reference signs

| | |
|---|---|
| 100 | The apparatus for producing a non-pneumatic tire |
| 102 | tires |
| 104 | tread |
| 106 | outer side/surface of the tread |
| 108 | inner side/surface of the tread |
| 110 | mold |
| 112 | forming surface |
| 114 | hydraulic and/or pneumatic tool |
| 116 | mixing head |
| 118 | cavity |
| 120 | reaction mixture |
| 122 | first reactive component |
| 124 | second reactive component |
| 126 | solid foam |
| 200 | apparatus for producing a non-pneumatic tire |
| 202 | injection unit/injection and closing unit |
| 204 | plastic melt |
| 206 | solid plastic material |

1. A method for producing a non-pneumatic tire (102), which has a tread (104), comprising a tire tread, having an outer side (106) and an inner side (108) opposite to the outer side (106), wherein the method comprises the following steps:
providing the tread (104) substantially in ring shape within a mold (110), comprising a tire mold;
pressing the tread (104), on its outer side (106), against a forming surface (112), comprising a shaping surface, of the mold (110); and
introducing a temporarily heat-emitting compound (120, 204) into the cavity (118) delimited by the tread (104),
wherein the heat emitted by the compound (120, 204) introduced into the cavity (118) causes or at least initiates vulcanization of at least one section of the tread (104),
wherein the heat-emitting compound (120, 204) is a reactive mixture (120) consisting of at least two reactive components (122, 124), comprising polyol and isocyanate, comprising a polyurethane reactive mixture,
or that the heat-emitting compound (120, 204) is a melt (204), comprising a plastic melt.

2. The method according to claim 1, wherein the tread (104) is produced at least in some sections from a natural rubber material or will be produced before the tread (104) is provided inside the mold (110).

3. The method according to claim 1, wherein a reinforcing layer, comprising a metal-reinforced natural rubber or elastomer layer, is attached to the inner side (108) of the tread strip (104).

4. The method according to claim 1, wherein an adhesion promoter is applied to the inner side (108) of the tread strip (104) or to an inner side (108) of the reinforcing layer.

5. The method according to claim 1, wherein a profile surface, comprising a tire profile, is produced by pressing the tread (104), on its outer side (106), against the forming surface (112) of the mold (110).

6. The method according to claim 1, wherein a hydraulic and/or pneumatic tool (114), comprising a pressing tool, is introduced at least in sections into the cavity (118) delimited by the tread (104), wherein the tread (104), on its outer side (106), is pressed, by compression, against the forming surface (112) of the mold (110) by actuating the tool (114).

7. The method according to claim 1, wherein the mold (110) is heated, by means of a heating device.

8. The method according to claim 1, wherein the heat-emitting compound (120, 204), comprising the reactive mixture (120), is introduced, by being injected or poured, into the cavity (118) delimited by the tread (104) by means of a mixing head (116), comprising a low-pressure or high-pressure mixing head.

9. The method according to claim 1, wherein the vulcanization of at least one section of the tread (104) is carried out or at least initiated by means of the temperature of the mold (110) and/or by means of the exothermicity of the reaction and/or polymerization reaction of the reactive mixture (120).

10. The method according to claim 9, wherein the reaction and/or polymerization process of the reactive mixture (120) takes place or is at least initiated simultaneously or with overlap.

11. The method according to claim 9, wherein a temperature level is maintained or variably adjusted until the reaction and/or polymerization process of the reactive mixture (120) and/or the vulcanization is completed.

12. The method according to claim 9, wherein an exothermic level of the reaction and/or polymerization reaction of the reactive mixture (120) is maintained and/or the reaction and/or polymerization process of the reactive mixture (120) takes place until the vulcanization is completed.

13. The method according to claim 1, wherein the heat-emitting compound (120, 204), comprising the melt (204), is introduced, by injection, into the cavity (118) delimited by the tread (104) by means of an injection unit (202) of an injection molding machine.

14. The method according to claim 1, wherein the mold (110) is coupled with the injection unit (202) or with an injection and closing unit (202) of an injection molding machine.

15. The method according to claim 1, wherein the vulcanization of at least a section of the tread (104) is carried out or is at least initiated by means of the melt temperature.

16. The method according to claim 1, wherein the melt temperature is maintained, above the temperature of the mold (110), until the vulcanization is completed.

17. The method according to claim 1, wherein melt cooling and vulcanization take place simultaneously or with overlap.

18. The method according to claim 1, wherein at least one supporting structure, comprising an insert, is introduced into the cavity (118) delimited by the tread (104).

19. An apparatus (100, 200) for producing a non-pneumatic tire (102), which has a tread (104), comprising a tire tread, having an outer side (106) and an inner side (108) opposite to the outer side (106), wherein the apparatus (100, 200) is configured and intended to carry out a method according to claim 1.

20. The apparatus (100, 200) according to claim 19, wherein the apparatus (100, 200) comprises a mold (110), comprising a tire mold, which has a forming surface (112), comprising a shaping surface, for forming the tread (104), on the outer surface (106) of the tread (104).

21. The apparatus (100, 200) according to claim 20, wherein the forming surface (112) is a contoured surface and/or has a profile designed to be complementary to a tire profile.

22. The apparatus (100, 200) according to claim 19, wherein the apparatus (100, 200) has a heating device for heating the mold (110), comprising the forming surface (112).

23. The apparatus (100, 200) according to claim 19, wherein the apparatus (100, 200) has a hydraulic and/or pneumatic tool (114) which can be introduced at least in sections into the mold (110) and is designed to press, via compression, the tread (104), on its outer side (106), against the forming surface (112) of the mold (110).

24. The apparatus (100, 200) according to claim 23, wherein the hydraulic and/or pneumatic tool (114) is a pressing tool and/or a hydraulically and/or pneumatically operable bellows.

25. The apparatus (100, 200) according to claim 19, wherein the apparatus (100, 200) has a mixing head (116) or a reaction casting plant having a mixing head (116) for introducing the heat-emitting compound (120, 204), comprising the reaction mixture (120), into the cavity (118) delimited by the tread (104).

26. The apparatus (100, 200) according to claim 19, wherein the apparatus (100, 200) has an injection unit (202) or injection and closing unit (202) or an injection molding machine having injection unit (202) or injection and closing unit (202) for introducing the heat-emitting compound (120, 204), comprising the melt (204), into the cavity (118) delimited by the tread (104).
